(19) United States
(12) Patent Application Publication
(10) Pub. No.: US 2005/0187665 A1
(43) Pub. Date: Aug. 25, 2005

(54) Automatic yard moisture control system

(75) Inventor: Zhen Fu, Raleigh, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/784,414

(22) Filed: Feb. 23, 2004

(51) Int. Cl. G05D 7/00

(52) U.S. Cl. 700/284; 239/69

(57) ABSTRACT

An automated moisture control network system is disclosed which enables automated maintenance of moisture levels for landscaping features and control of the systems that perform the maintenance operations. The maintenance operations are controlled based on environmental conditions affecting the landscaping features and systems, including weather forecasting, research regarding the different plants and grasses being maintained by the system, geographical information (soil, climate, etc.) for the region in which the landscaping features are situated, and real-time data regarding current moisture, temperature, and other environmental conditions.

### BACKGROUND OF THE INVENTION

1. Field of the Invention

This invention relates to computerized monitoring and control of moisture levels and, more particularly, to computer monitoring control of moisture levels in residential landscaping.

2. Description of the Related Art

There has always been a segment of the population that spends significant time and money in planning, installing, and maintaining gardens, yards, and other forms of landscaping. On a small scale, such people typically are homeowners; on a larger scale, college-trained groundskeepers care for and maintain fields and gardens at such diverse locations as sports stadiums, golf courses, and theme parks (e.g., Disney World) to name but a few.

In view of the large investment of time and money in such pursuits, great care must be taken to assure that landscaping receives appropriate moisture content, typically in the form of watering. Numerous factors come into play when determining the appropriate amount of moisture to maintain and/or dispense in a particular landscape environment, including the types of plants/grasses in the landscaping, their age, condition, environment, exposure to natural forms of moisture, and the like. Sophisticated systems for monitoring and control of commercial operations, such as stadiums, amusement parks, and the like, are known. These systems are complex, expensive, and rely on the expertise of hired groundskeepers to operate.

For smaller-scale consumer needs (e.g., the individual homeowner), automatic maintenance and control systems are lacking. Typically, a homeowner manually observes the condition of the landscaping, and may manually monitor local weather conditions, and then decide when and where to dispense moisture. This typically takes the form of turning on a sprinkler or sprinkler system, allowing it to run for a period of time, and then terminating the moisture delivery at a predetermined time. This method is imprecise and involves significant guesswork. Automated systems are available at some level, but they typically involve clock/timer systems that activate and deactivate sprinkler systems at predetermined times and for predetermined time intervals. In addition, the average consumer does not possess anything more than rudimentary knowledge regarding the specific maintenance needs of plants and other landscaping features in their yard and the soils in which they are planted.

Accordingly, it would be desirable to have an automatic system directed to the consumer market that requires essentially no human attention and that automatically monitors aspects of importance to landscaping maintenance at all times and institutes, monitors, and controls moisture delivery in an optimized manner, without requiring expertise on the part of the consumer utilizing the system.

### SUMMARY OF THE INVENTION

The present invention is an automated moisture control network system that enables automated maintenance of moisture levels for landscaping features and control of the systems that perform the maintenance operations. The invention factors in environmental conditions affecting the landscaping features and systems, including weather forecasting, research regarding the different plants and grasses being maintained by the system, geographical information (soil, climate, etc.) for the region in which the landscaping features are situated, and real-time data regarding current moisture, temperature, and other environmental conditions. In a preferred embodiment, actual or forecast temperatures are monitored so that, in the event of actual or forecast freeze conditions, the system automatically suspends water delivery and flushes/drains the water delivery system to avoid system damage.

### BRIEF DESCRIPTION OF THE DRAWINGS

FIG. 1 is a block diagram illustrating an example of the system of the present invention and an environment in which it may be used; and

FIG. 2 is a flowchart illustrating the basic steps performed in connection with operation of the system illustrated in FIG. 1.

### DETAILED DESCRIPTION OF THE PREFERRED EMBODIMENTS

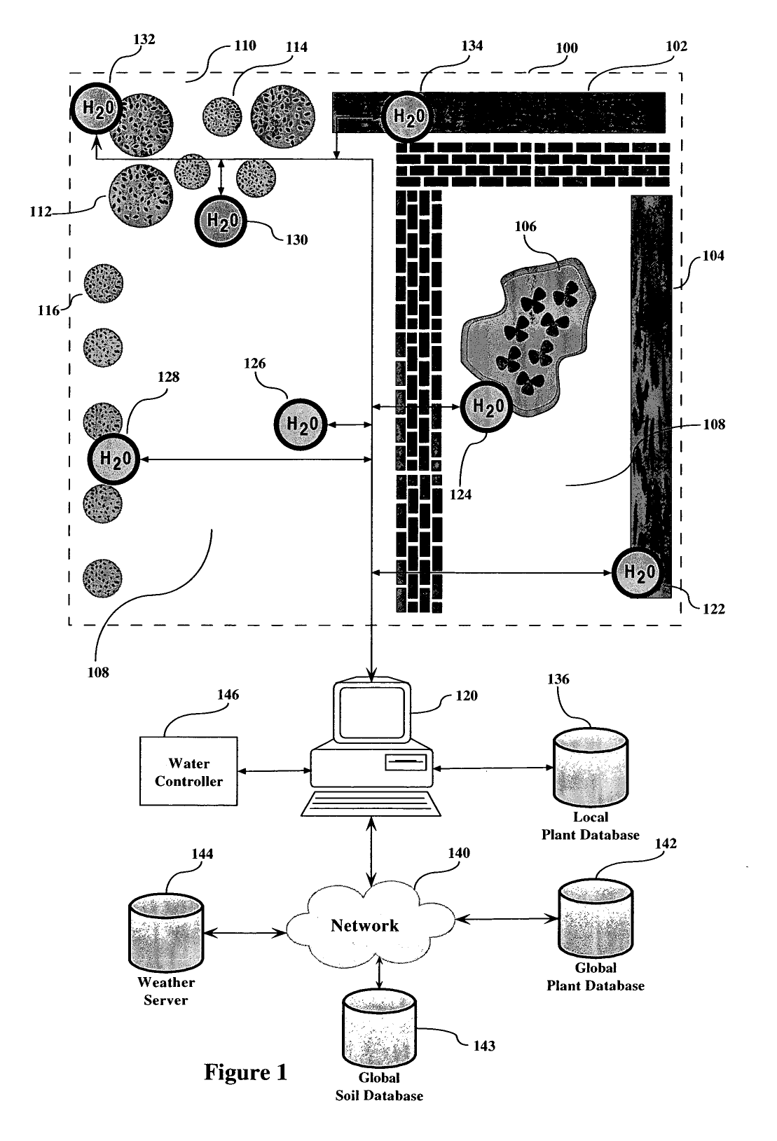

FIG. 1 is a block diagram illustrating an example of the system of the present invention and an environment in which it may be used. Referring to FIG. 1, an area 100, such as a yard, contains various landscaping features to be monitored and maintained. The term “landscaping features” is used herein to refer to any plants, bushes, flowers, trees, or other live plants for which monitoring and maintenance is contemplated. A processing system 120, for example, a PC, facilitates the monitoring and control of the area 100 and maintenance systems thereof.

Processor 120 is illustrated as being coupled to a local plant database 136 and a water controller 146. It is understood that, while in this block diagram these elements are illustrated as separate elements from the processor 120, one or both of these elements can be integrated into the processor 120 via hardware, software, or both. In one embodiment, processor 120 is located in a house or building associated with area 100. In an alternative embodiment, processor 120 is located in a remote location relative to area 100, such as a management company that provides an off-site monitoring service for area 100, as possibly other areas as well. Networking capability to provide this remote function is well known in the art and is not described further herein.

Processor 120 also includes a network connection 140 giving processor 120 access to networks, such as the Internet, which in turn give processor 120 access to public servers and databases such as global plant databases 142, global soil databases 143 and weather servers 144. Details of all of these elements will be described in more detail below. It is preferable that network connection 140 be an “always-on” connection, such as cable, DSL, T1, or other similar network connection.

Area 100 in this illustration is a yard such as that which might be found in any suburban location. Area 100 in this example includes hedgerows 102 and 104, flowerbed 106, yard (grass) areas 108, a “grove” of trees, in this example consisting of different types of trees, in this example trees 112 (represented by the larger circles) and smaller trees 114 (represented by smaller circles). In addition, a row of identical trees 116 occupy a border of the area 100.

One aspect of the present invention is the real-time monitoring of environmental conditions in various portions of the area 100. In particular, common areas (areas containing common elements, such as only grass, only a certain kind of tree, etc.) are separately monitored. In the example of FIG. 1, moisture sensors 122, 124, 126, 128, 130, 132, and 134 are situated at various locations throughout the area 100 and are coupled to processor 120 so that any moisture readings taken by them are delivered and stored in processor 120. As can be seen in the example of FIG. 1, in a common area (for example, an area containing only a hedge, or a single type of tree or grass), a single moisture sensor can be utilized since it will be assumed that the moisture condition and moisture needs for the entire common area is represented by the moisture sensed at the site of the sensor. Thus, for example, a single moisture sensor 122 is associated with hedgerow 104, a single moisture sensor 124 is associated with flowerbed 106, a single moisture sensor 126 is associated with yard area 108, and a single moisture sensor 128 is associated with the row of trees 116. In the area of the yard where diverse-elements are intermingled, e.g., the tree grove 110, two sensors are installed, moisture sensor 130 and moisture sensor 132, so that moisture levels respecting the larger trees 112 can be measured while moisture levels in the portion of the grove occupied by smaller trees 114 can be separately measured. Obviously, more or less sensors may be used in area 100, depending upon the precision with which measurements are needed and/or desired. Further, a single sensor can monitor the diverse-element areas, as long as there is a way to separately control moisture to the diverse elements (e.g., separate sprinkler heads for each element, with software control of activation/deactivation of each sprinkler head).

Water controller 146 controls the flow of moisture delivery throughout the area 100. Although not shown, a sprinkler system, for example, can be placed on the surface of area 100 (e.g., using hoses and sprinkler heads) or underground in a well known manner, and the sprinkler heads placed at one or more locations in the yard are controlled by water controller 146. Computer-controlled remote systems for controlling the delivery of moisture to yards, farm fields and other locations are well known in the art and the specific details thereof are not described further herein. In accordance with the present invention, it is optimal to correlate the moisture sensors 122 through 134 with moisture delivery elements in the yard, so that, for example, if there is an indication of a need for moisture for the flowerbed 106, as indicated by moisture sensor 124, water controller 146, in connection with processor 120, can automatically deliver moisture to a sprinkler head adjacent to flowerbed 106 and the landscaping features being monitored by moisture sensor 124. As noted above, a single sensor can be associated with multiple sprinkler heads, and each sprinkler head may be separately controllable so that, for example, a sensor monitoring a diverse-element area can be used to control activation of one sprinkler head but not another.

In accordance with the present invention, conditions other than just moisture as sensed by moisture sensors 122 through 134 are utilized in control of the moisture delivery system. Local plant database 136 is configured by a user of the system to contain landscaping-care data regarding the specific plants/grasses and other elements being monitored and maintained by the system. For example, trees 112 and trees 114 and 116 may have completely different needs with respect to moisture levels, temperatures and the like. Local plant database 136 maintains information regarding each element including its moisture needs, care instructions and the like. Initially, the user of the system inputs the name of each plant/grass/landscape element. If known, the user may input additional information, such as the moisture needs, case instructions, etc. However, in accordance with the present invention, the user does not need to possess this level of expertise in landscaping. As described below, the present invention also accesses publically available landscaping-care databases, e.g., databases available via the Internet. Accordingly, as long as the user can identify the name of the landscaping element, the care information and other maintenance data can be automatically obtained via these off-site databases thereby simplifying the operation and minimizing the level of expertise needed by the user of the system.

In addition, if known, local plant database 136 may also contain data regarding the age of the monitored elements. For example, a ten-year-old tree may have different maintenance needs than a one-year-old tree or a 50-year-old tree. By storing this information in local plant database 136, water controller 146, in connection with processor 120 and any monitoring equipment, can be utilized to factor in specific elements regarding the plants in area 100. It is contemplated that, in a typical scenario, at least the basic information in the local plant database 136 will be input/downloaded by a user of the system, i.e., one who has specific knowledge about the particular landscaping elements in the area 100.

As described above, in addition to specific information regarding the plants, soils, and conditions in area 100 stored in local plant database 136, network connection 140 gives the system access to other information, including weather data and resources providing further landscaping-care information regarding the plants, soils and region in which the area 100 is located. For example, global plant database 142 is representative of one or more publically or privately available network resources where information is provided regarding regional maintenance requirements for plants, grasses, and trees, or any other information of similar nature which would be of interest to someone maintaining area 100, e.g., www.plantcare.com; www.NeoFlora.com. A separate global soil database 143 is also shown in FIG. 1, and is representative of one or more soil websites or databases (a Google search for the term “soil database” reveals many) that provide data regarding soils on a regional basis, and/or data regarding specific soil types (e.g., red clay). Weather server 144 is representative of one or more weather websites or databases accessible via network connections such as the Internet which give weather forecasts, current weather conditions, and other weather-related information (e.g., www.weather.com). Information from these sources is obtained/extracted by processor 120 using known techniques, in addition to the information from local plant database 136 and moisture sensors 122 through 134. Information for the appropriate area may be identified, for example, by having a user of the system supply their postal zip code, thereby identifying a region for which additional data may be desired, and configuring processor 120 to extract relevant information from the data. Global or local databases for any other desired conditions or elements may be accessed in the same manner and are covered by the claims herein.

Armed with all of this information, processor 120 can calculate moisture needs for, at minimum, the portions of area 100 proximate to sensors 122 through 134, and water controller 146 can then be utilized to provide moisture to the various portions of the area 100. Taking into consideration the moisture levels, the needs of the various plants/grasses/trees, the weather forecast, the soil information, and any other information obtained by processor 120, the moisture delivery time utilized for the various portions of the yard may be controlled. For example, flowerbed 106 may require only 15 minutes of watering during early morning hours, while tree grove 110 may require 3 hours of watering during periods of maximum sunlight. Each of the various areas to which water is delivered can be independently controlled, considering all of the elements input to processor 120.

If, for example, the weather forecast indicates a certain threshold percentage likelihood (e.g., 70% or greater) of rain within the next 24 hours, water controller 146 might be programmed to delay providing moisture to one or more areas of area 100 for a period of time, thus allowing moisture to be provided naturally from the rain. Further, the moisture sensors can be monitored on a real-time basis so that, once a moisture level at a particular moisture sensor reads a predetermined moisture level, this information is used by the processor and water controller to cut off the delivery of moisture to the appropriate sprinkler heads.

Using the system of the present invention, minimal human attention is needed to maintain moisture levels in a yard or other area on a year-round basis. Further, the providing of moisture can be done with precision, i.e., the amount of water provided will vary depending upon the environmental conditions, and not simply based upon use of a timer or other imprecise means.

In accordance with another embodiment, non-plant-related maintenance can also be performed using the present invention. In this embodiment, draining and shutting off of water pipes during cold temperatures is performed automatically, and in advance, based upon weather forecasting and temperature monitoring. A process (e.g., a Daemon-like process) is run in the background of processor 120 at all times. Processor 120 is configured to send a request to water controller 146, when the temperature drops close to 32° F., to release all water currently in the pipes and shut down the system until further notice (or until the temperature goes to a predetermined level above freezing). In addition, if desired, the system can be configured to perform the same operation based on forecast weather data rather than actual weather data, so that, for example, if the forecast calls for freezing temperatures, the pipes can be drained and the system shut down in advance, based upon the forecast. This embodiment eliminates the need for the system user to manually shut-off and drain pipes in freeze conditions.

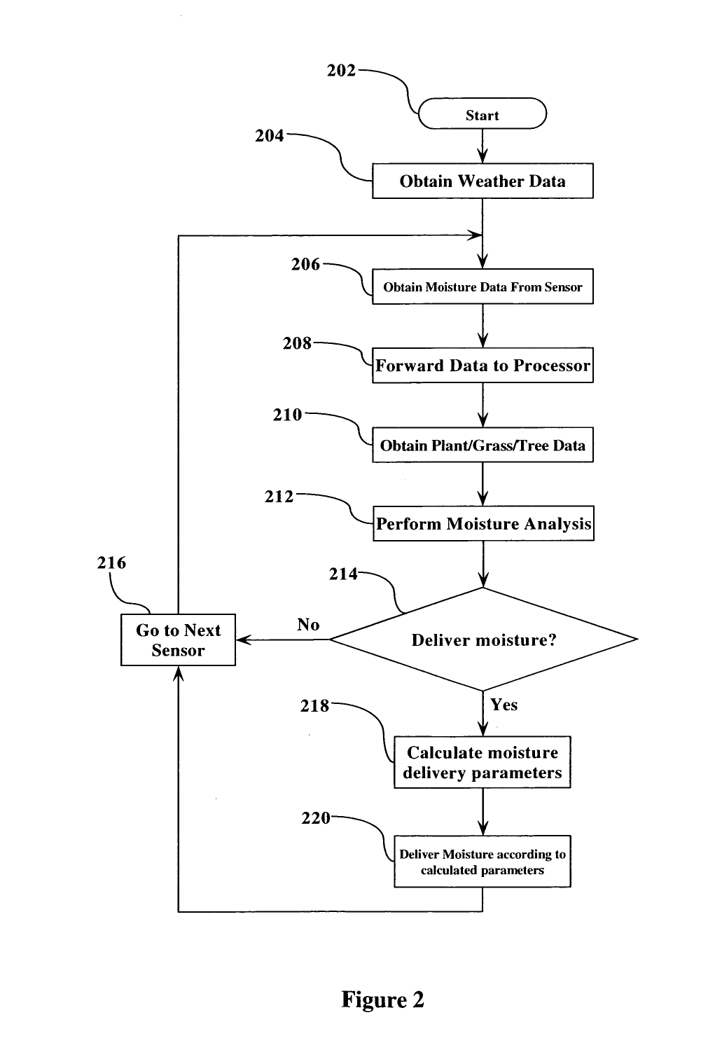

FIG. 2 is a flowchart illustrating the basic steps performed in connection with operation of the system illustrated in FIG. 1. Referring to FIG. 2, the process begins at step 202, and at step 204 weather data for the area is obtained. For example, a user of the system can input a postal zip code which will result in weather data for that area to be downloaded to the processor. In addition, although not shown, if desired, weather equipment (temperature sensors, humidity sensors, barometric pressure sensors, etc.) can be situated in the monitoring area and coupled to the processor and provide weather data thereto. If temperature sensors and/or forecasts indicate freezing conditions, the system can automatically shut off water flow, drain the pipes and maintain this state until such time as the freeze conditions are no longer occurring.

Although weather data can be obtained each time the process of FIG. 2 is performed, in general, this process will be performed for the entire yard on a periodic basis. Thus, if the process is performed in a serial manner, that is, if each sensor is individually processed during a particular analysis operation for the entire area, the weather conditions will not likely change significantly with respect to that instance. In other words, each time the yard is analyzed in its entirety, either in serial or parallel, the weather data needs to be obtained only once. If desired, however, actual temperatures can be constantly monitored so that, if freezing conditions are approached or reached, the system can automatically drain and shut off all moisture delivery until the temperatures rise above freezing conditions. Further, weather alerts and/or forecasts can be monitored for potential freeze conditions, for the same purpose.

At step 206, moisture data is obtained from a first sensor of the system. At step 208, the moisture data obtained from the first sensor is forwarded to the data processor. At step 210, plant/grass/tree/soil data related to the specific plants/grasses/trees/soils in the area being maintained is obtained from local and/or global databases. As discussed above, this information can be broad in nature, i.e., general or specific information regarding plants/grasses/trees/soils in the region where the yard or other area being monitored is located, and/or general or specific information regarding the particular plants/grasses/trees/soils in the yard.

At step 212, moisture analysis is performed on the area being maintained. For example, a determination is made as to whether or not the moisture sensors indicate a need for delivery of additional moisture, and the assessment of this need is based not only on the moisture level, but also on the specific data regarding plants situated around the particular sensor.

At step 214, a determination is made as to whether or not, based upon the moisture analysis, it is appropriate to deliver moisture to the plants around (or associated with) the sensor. If the analysis indicates that there is no need to deliver moisture at this time, the process proceeds to step 216, and the next sensor is used to perform the same steps (steps 206 through 214).

If the analysis indicates the need for the delivery of moisture, then the process proceeds to step 218 where moisture delivery parameters are calculated. The calculation of the moisture delivery parameters includes analysis of current weather and forecasted weather. For example, if there is an indication that rain is likely to occur, the moisture delivery by processor 120 may be shortened in duration to account for the fact that additional moisture will be provided naturally in the upcoming hours or days. It is understood that the particular calculation used is up to the desires of the manufacturer and/or user of the system itself, and that any calculations may be used which will satisfy the desires of the manufacture/user. At step 220, the moisture is delivered according to the calculated parameters, and then the process proceeds to step 216 where the next sensor is utilized to perform the same steps.

Although the present invention is described in FIG. 2 as performing the process on a sensor-by-sensor basis, it is understood and contemplated that all sensors can be read essentially simultaneously and the process of steps 206 through 220 can be performed essentially in parallel for each sensor if desired.

Although the process described with respect to FIGS. 1 and 2 is described with respect to maintenance and control of moisture delivery to a yard area, it is understood that the present invention has equal applicability to farm irrigation, greenhouse watering and the like, and can also be used to control the delivery of other materials (e.g., fertilizer, plant food, etc.) as long as sensor data or other data is available that enables the calculation of proper amounts of the materials, and a delivery system for controlling flow of the materials is in place.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of processor 120. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-2 support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A moisture control system for a residential landscaping area having one or more landscaping elements, comprising:
a moisture delivery system controllable to provide moisture to the landscaping area; and
a moisture control processor, coupled to said moisture delivery system, configured with:
real-time weather data for the landscaping area;
real-time moisture data for the landscaping area; and
landscaping-care data for the landscaping area;
wherein said landscaping area has a residence located thereon and wherein said moisture control processor is located within said residence:
wherein said moisture control processor comprises a personal computer configured to wirelessly access said real-time weather, moisture and/or landscaping-care data: and
whereby said moisture delivery system is controlled by said moisture control processor to deliver moisture and/or cease delivery of moisture to the landscaping area based on said weather, moisture, and/or landscaping-care data.

2. The system of claim 1, wherein said landscaping-care data includes data specific to each landscaping element in said landscaping area.

3. The system of claim 2, wherein said data specific to each landscaping element further includes the type of landscaping element.

4. The system of claim 3, wherein said data specific to each landscaping element further includes the name of each landscaping element.

5. The system of claim 4, wherein said data specific to each landscaping element further includes the age of at least one of said landscaping elements.

6. The system of claim 5, wherein said data specific to each landscaping element further includes a recommended moisture level for at least one of said landscaping elements.

7. The system of claim 6, wherein said data specific to each landscaping element further includes the soil type(s) in which the landscaping elements are planted.

8. The system of claim 1, wherein said moisture control processor drains and shuts down said moisture delivery system when said real-time weather data indicates that a temperature at the landscaping area has reached a predetermined threshold temperature.

9. The system of claim 1, wherein said moisture control processor drains and shuts down said moisture delivery system when said real-time weather data indicates that a temperature at the landscaping area has been forecasted to reach a predetermined threshold temperature.

10. (canceled)

11. The system of claim 1, wherein said real-time weather data is obtained from sensors located within the landscaping area.

12. The system of claim 1, wherein said real-time weather data is obtained from one or more weather databases accessible to said moisture control processor.

13. The system of claim 12, wherein said one or more weather databases include one or mores weather databases accessible via the Internet.

14. The system of claim 1, wherein said real-time moisture data is obtained from one or more moisture sensors situated in the landscaping area.

15. The system of claim 1, wherein said landscaping-care data is obtained from one or more landscaping databases accessible to said moisture control processor.

16. The system of claim 15, wherein at least one of said one or more landscaping databases is a local database maintained by a user of the moisture delivery system.

17. The system of claim 15, wherein at least one of said one or more landscaping database is a global database accessible to said moisture controller via a network connection.

18. (canceled)

19. A method of moisture control for a residential landscaping area having one or more landscaping elements, and one or more moisture delivery systems, comprising:
providing a moisture control processor with real-time weather data for the landscaping area;
providing the moisture control processor with real-time moisture data for the landscaping area;
providing the moisture control processor with landscaping-care data for the landscaping area; and
controlling a flow of moisture to the landscaping area based on said real-time weather, moisture, and/or landscaping-care data;
wherein said landscaping area has a residence located thereon and wherein said moisture control processor is located within said residence: and
wherein said moisture control processor comprises a personal computer configured to wirelessly access said real-time weather moisture and/or landscaping-care data.

20. The method of claim 19, wherein said landscaping-care data includes data specific to each landscaping element in said landscaping area.

21. The method of claim 20, wherein said data specific to each landscaping element further includes the type of landscaping element.

22. The method of claim 21, wherein said data specific to each landscaping element further includes the name of each landscaping element.

23. The method of claim 22, wherein said data specific to each landscaping element further includes the age of at least one of said landscaping elements.

24. The method of claim 23, wherein said data specific to each landscaping element further includes a recommended moisture level for at least one of said landscaping elements.

25. The method of claim 24, wherein said data specific to each landscaping element further includes the soil type(s) in which the landscaping elements are planted.

26. The method of claim 19, wherein said controlling of moisture flow includes the draining of all moisture delivery systems and ceasing of moisture delivery when said real-time weather data indicates a temperature at the landscaping area has reached a predetermined threshold temperature.

27. The method of claim 19, wherein said controlling of moisture flow includes the draining of all moisture delivery systems and ceasing of moisture delivery when said real-time weather data indicates a forecast temperature for the landscaping area of a predetermined threshold temperature.

28. (canceled)

29. The method of claim 19, wherein said real-time weather data is obtained from sensors located within the landscaping area.

30. The method of claim 19, wherein said real-time weather data is obtained from one or more weather databases accessible to said moisture control processor.
